(19) United States
(12) Patent Application Publication
(10) Pub. No.: US 2016/0148006 A1
(43) Pub. Date: May 26, 2016

(54) Privacy User Interface for Websites

(71) Applicant: Microsoft Technology Licensing LLC, Redmond, WA (US)

(72) Inventors: Swathi Ganapathi, Seattle, WA (US); Zachary M. Murphy, Seattle, WA (US); Danielle R. Jaegers, Sammamish, WA (US); Dalen M. Abraham, Duvall, WA (US)

(21) Appl. No.: 14/550,825

(22) Filed: Nov. 21, 2014

(51) Int. Cl. G06F 21/62; H04L 29/08

(52) U.S. Cl. CPC G06F 21/62; H04L 67/02

(57) ABSTRACT

A privacy user interface for websites is described. In one or more implementations, website information associated with a website is detected responsive to navigating to the website using a web platform. The website information may include third party entities associated with the website, privacy settings of the website, and/or browser notifications associated with the website. The website information is then displayed in a privacy user interface to enable a user of the web platform to view the website information associated with the website. The privacy user interface further includes one or more privacy controls useable to take specific actions with regards to the third party entities, such as by blocking or preventing the third party entities from tracking navigation to the website or accessing information exchanged with the web site, or by modifying the privacy settings of the web site.

### BACKGROUND

Users of web browsers today are often unaware that, when navigating to a website, information is often exchanged with third party entities associated with the website, such as third party tracking sites. Such third party entities may gather information about the user from multiple websites visited by the user, and use the information to build a robust profile of the user without the user's knowledge or permission. Conventional web browsers fail to notify users of third party entities, and thus users of conventional web browsers often unknowingly exchange information with a variety of different third party entities while browsing.

### SUMMARY

A privacy user interface for websites is described. In one or more implementations, website information associated with a website is detected responsive to navigating to the website using a web platform. The website information may include third party entities associated with the website, privacy settings of the website, and/or browser notifications associated with the website. The web site information is then displayed in a privacy user interface to enable a user of the web platform to view the website information associated with the website. The privacy user interface further includes one or more privacy controls useable to take specific actions with regards to the third party entities, such as by blocking or preventing the third party entities from tracking navigation to the website or accessing information exchanged with the website, or by modifying the privacy settings of the web site.

In one or more implementations, websites navigated to using a web platform, as well as third party entities associated with one or more of the websites, are detected. As described herein, the term “website” refers to first party sites that the user has taken an explicit action to visit using the web platform, and the term “third party entity” refers to any sub download on the first party site that does not originate from the first party domain. Relationships between the detected websites and the detected third party entities are mapped. In one or more implementations, a graph that depicts the relationships between the websites and the third party entities can be displayed in the privacy user interface.

In one or more implementations, a web platform is configured to display a privacy user interface that includes a privacy portion and a settings portion. The privacy portion includes a third party entity list of one or more third party entities associated with a website navigated to using the web platform, and a block control selectable to prevent the one or more third party entities from tracking navigation to the website or accessing information exchanged with the website. Selection of the block control prevents the third party entity from being downloaded on future visits to the first party site and on any other first party site that the user visits in the future. The settings portion includes indications of privacy settings associated with the website, and one or more controls selectable to modify the privacy settings. In one or more implementations, the privacy user interface further includes a notification portion that includes indications of one or more notifications associated with the website.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The same numbers are used throughout the drawings to reference like features and components.

FIG. 1 is an illustration of an environment in an example implementation that is operable to support techniques described herein

FIG. 2 illustrates a system in which a privacy monitoring module detects website information, and presents the website information in a privacy user interface.

FIG. 3 illustrates an example of a privacy user interface displaying indications of detected third party entities associated with a website in accordance with one or more implementations.

FIG. 4 illustrates an example of a privacy user interface displaying a list of first party websites associated with a third party entity in accordance with one or more implementations.

FIG. 5 illustrates an example of a privacy user interface displaying a graph view of the relationship between first party websites and third party entities across a user's browsing history in accordance with one or more implementations.

FIG. 6 illustrates an example of a privacy user interface displaying privacy and/or security settings associated with a website in accordance with one or more implementations.

FIG. 7 illustrates an example of a privacy user interface displaying notifications associated with a website in accordance with one or more implementations.

FIG. 8 illustrates an example method of detecting website information associated with a website, and displaying a privacy user interface.

FIG. 9 illustrates an example method of mapping relationships between websites navigated to using a web platform and third party entities.

FIG. 10 illustrates an example system that includes an example device, which can implement embodiments of a privacy user interface for websites.

### DETAILED DESCRIPTION

### Overview

When a user navigates directly to a first party website using a web platform (e.g., a web browser) there is an explicit understanding that the first party website may access information from the user. However, users often do not realize that third party entities, such as third party trackers, may also be able to access information exchanged with the first party web site in order to generate a profile of the user. For example, these third party trackers may be implemented at multiple different websites that a user navigates to using a web platform, and thus are able to access information exchanged with each website visited by the user. For example, a third party tracking site may be able to track a user's navigation to seattleseahawks.com, followed by nordstrom.com/mensclothing, followed by nytimes.com. Based on the user's navigation, as well as information exchanged with each of these websites, the third party tracking site may be able to determine, at a minimum, that user is a male, living in Seattle, who likes sports and Nordstrom clothing, and reads the New York Times.

Conventional web browsers do not notify the user of third party entities associated with a current website that may be accessing information exchanged with the website. Further, conventional web browsers do not enable the user to view, for a particular third party entity, each of the websites at which the third party entity may have previously accessed information from the user. Thus, users often unknowingly lose their privacy by exchanging data with a variety of different third party entities.

In addition, users may unknowingly grant various permissions to websites to access specific information from the user, such as the user's geographic location. Thus, a user may unintentionally exchange information, such as the user's geographic location, with a website navigated to using a web platform.

In the techniques described herein, website information associated with a website is detected responsive to navigating to the website with a web platform. The website information may include third party entities associated with the website, privacy settings of the website, and/or notifications associated with the website. The website information is then displayed in a privacy user interface to enable a user of the web platform to view the website information associated with the current website. The privacy user interface further includes one or more privacy controls useable to take specific actions with regards to the third party entities, such as by blocking or preventing the third party entities from tracking navigation to the website or accessing information exchanged with the website, or by modifying the privacy settings of the website.

In one or more implementations, websites navigated to using a web platform, as well as third party entities associated with one or more of the websites, are detected. Relationships between the detected websites and the detected third party entities are mapped. In one or more implementations, a graph that depicts the relationships between the websites and the third party entities can be displayed in the privacy user interface.

In one or more implementations, a web platform is configured to display a privacy user interface that includes a privacy portion and a settings portion. The privacy portion includes a third party entity list of one or more third party entities associated with a website navigated to using the web platform, and a block control selectable to prevent the one or more third party entities from tracking navigation to the website or accessing information exchanged with the website. Selection of the block control prevents the third party entity from being downloaded on future visits to the first party site and on any other first party site that the user visits in the future. The settings portion includes indications of privacy settings associated with the website, and one or more controls selectable to modify the privacy settings. In one or more implementations, the privacy user interface further includes a notification portion that includes indications of one or more notifications associated with the website.

Thus, by bringing together multiple pieces of information regarding a website, the privacy user interface makes it easy for users to understand settings and browsing behavior related to the current website without having to decipher disparate pieces of information.

Example Environment

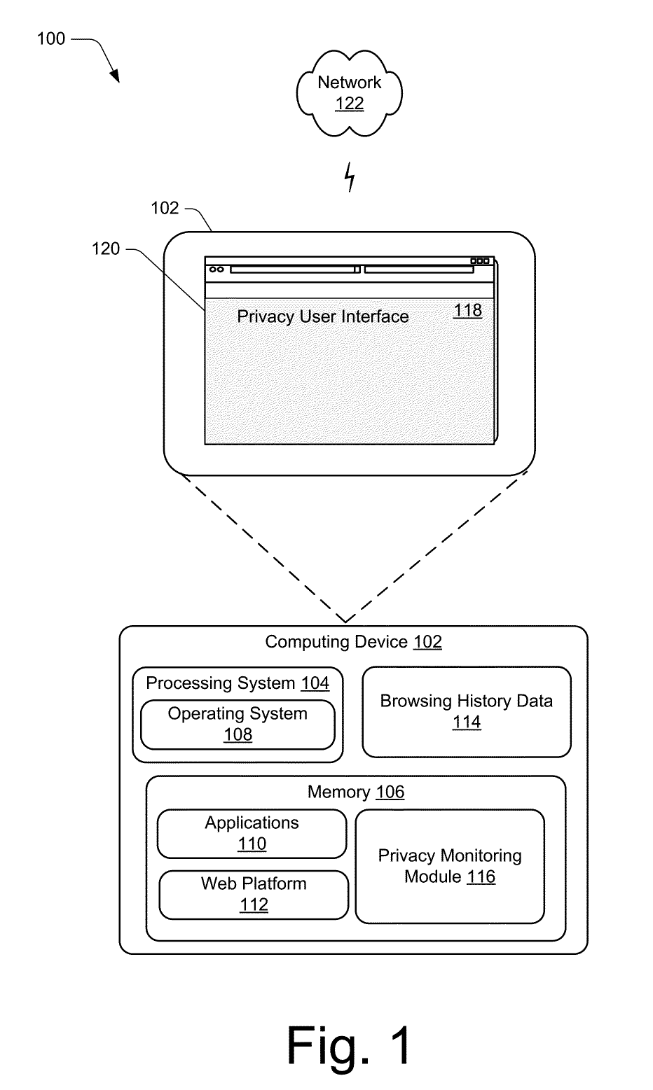

FIG. 1 is an illustration of an environment 100 in an example implementation that is operable to support techniques described herein. The illustrated environment 100 includes a computing device 102 having one or more hardware components, examples of which include a processing system 104 and a computer-readable storage medium that is illustrated as a memory 106 although other components are also contemplated as further described below.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, educational interactive devices, point of sales devices, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on. In addition, it may apply to apparatuses including a plurality of display devices.

The computing device 102 is further illustrated as including an operating system 108, although other embodiments are also contemplated in which an operating system is not employed. The operating system 108 is configured to abstract underlying functionality of the computing device 102 to applications 110 that are executable on the computing device 102. For example, the operating system 108 may abstract the processing system 104, memory 106, and/or network functionality of the computing device 102 such that the applications 110 may be written without knowing “how” this underlying functionality is implemented. The application 110, for instance, may provide data to the operating system 108 to be rendered and displayed without understanding how this rendering will be performed. The operating system 108 may also represent a variety of other functionality, such as to manage a file system and user interface that is navigable by a user of the computing device 102.

Computing device 102 also includes a web platform 112. Web platform 112 works in connection with content of the web, e.g. public content such as websites and the like. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platforms can include web browsers, local applications such as a Windows® Store application, and the like. In the examples described below, a web platform in the form of a web browser that navigates to various websites is utilized. It is to be appreciated and understood, however, that the inventive principles can be employed by web platforms other than web browsers.

Computing device 102 may include browsing history data 114 that stores web addresses (e.g., URLs) of websites navigated to using web platform 112. As described herein, the term “website” is used to refer to websites or web pages that can be navigated to via a web platform using a web address of the website. Examples of web addresses include uniform resource locators (URLs), uniform resource identifiers (URIs), internationalized resource identifiers (IRIs), and internationalized domain names (IDNs).

Computing device 102 is illustrated as including a privacy monitoring module 116 that is be stored on computer-readable storage memory (e.g., memory 106), such as any suitable memory device or electronic data storage implemented by the mobile device.

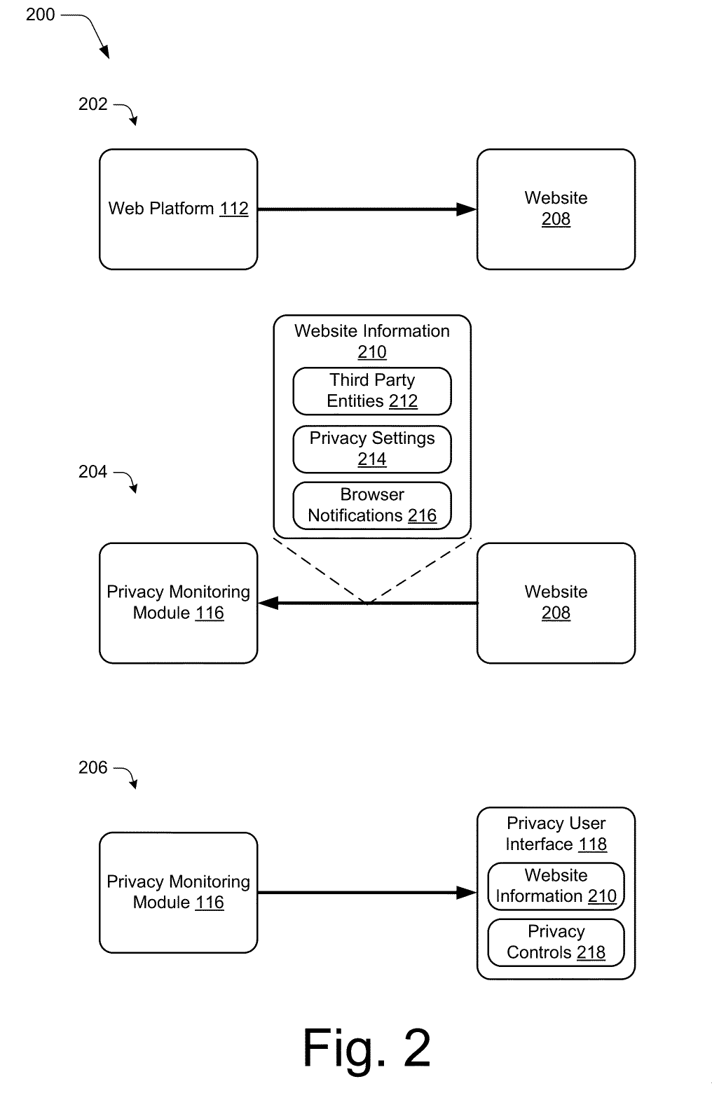

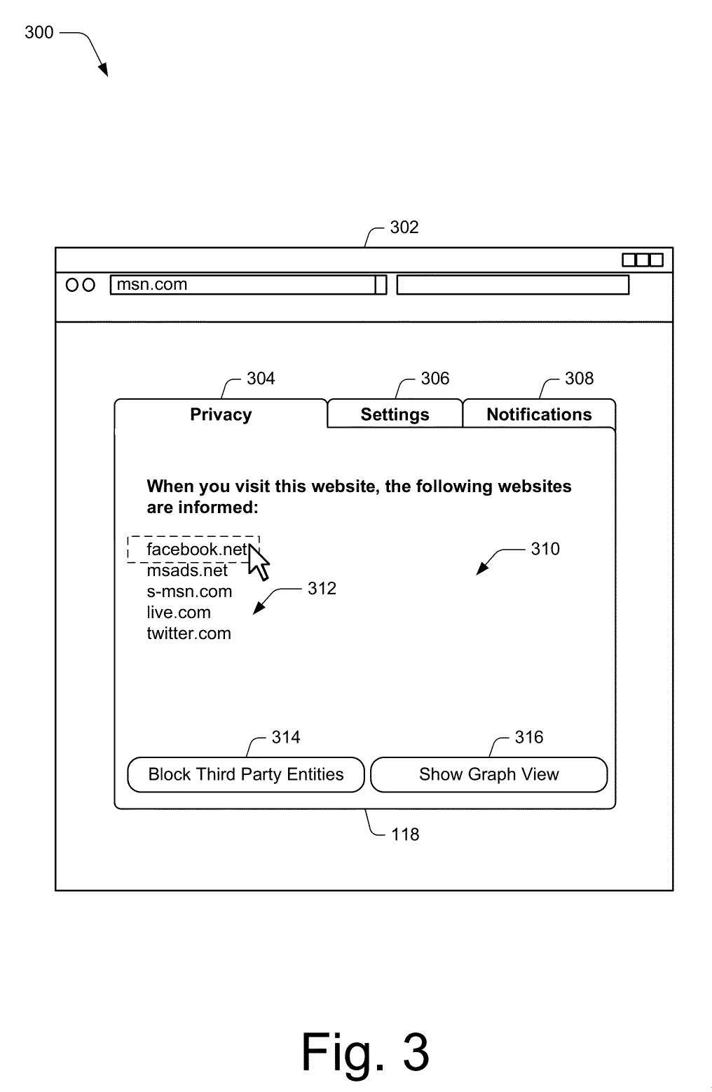

Privacy monitoring module 116 is representative functionality to detect website information associated with a website navigated to using web platform 112. The website information may include third party entities associated with the website, privacy settings of the website, and/or notifications associated with the website. The website information is then presented in a centralized privacy user interface 118 on a display 120 of computing device 102. Privacy user interface 118 enables a user of web platform 112 to view the website information associated with the current web site. Privacy user interface 118 further includes one or more privacy controls useable to take specific actions with regards to the third party entities, such as by blocking or preventing the third party entities from accessing information exchanged with the website, or by modifying the privacy settings of the website. Further discussion of privacy monitoring module 116 may be found below with reference to FIG. 2. Further discussion of privacy user interface 118, may be found below with reference to FIGS. 3-7.

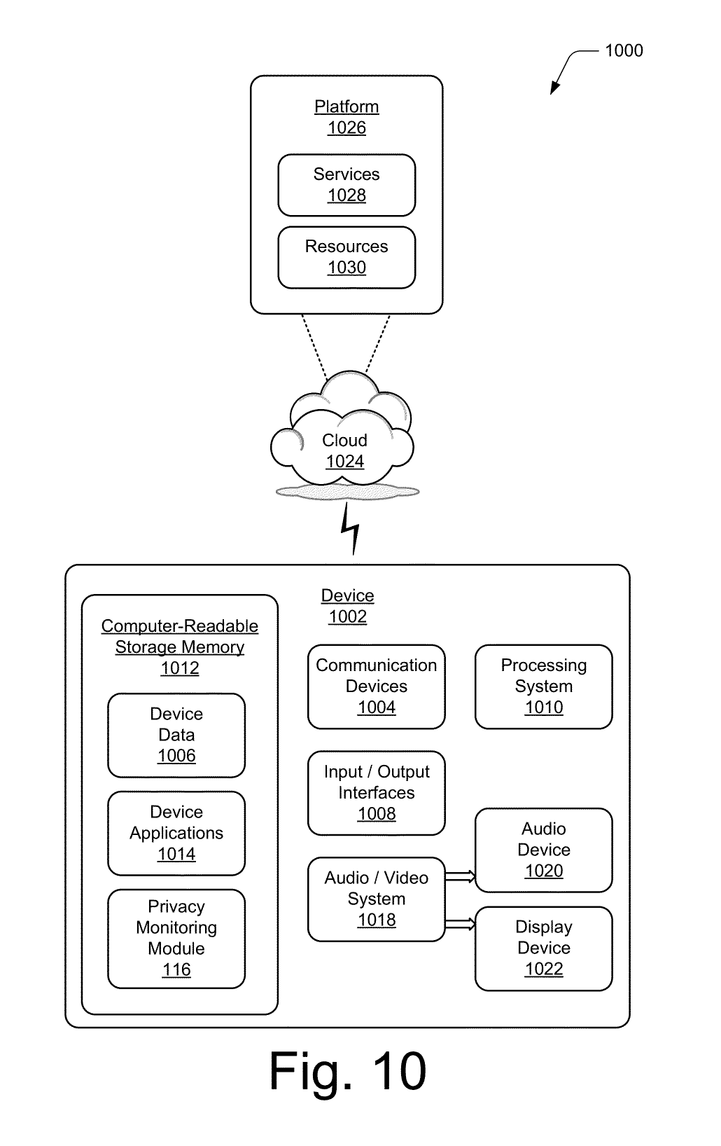

Although illustrated as part of computing device 102, functionality of privacy monitoring module 116 may also be implemented in a distributed environment, remotely via a network 122 (e.g., “over the cloud”) as further described in relation to FIG. 10, and so on. Although network 122 is illustrated as the Internet, the network may assume a wide variety of configurations. For example, network 122 may include a wide area network (WAN), a local area network (LAN), a wireless network, a public telephone network, an intranet, and so on. Further, although a single network 122 is shown, network 122 may also be configured to include multiple networks.

FIG. 2 illustrates a system 200 in which a privacy monitoring module detects website information, and presents the website information in a privacy user interface. System 200 is illustrated through the use of first, second, and third stages 202, 204, and 206.

At first stage 202, web platform 112 navigates to a website 208. As described herein, the term website is used to describe first party websites intentionally navigated to using web platform 112, such as by typing a URL of website 208 into an address bar of web platform 112, or by selecting a link that points to website 208.

At second stage 204, privacy monitoring module 116 detects website information 210 associated with website 208. Website information 210 may include third party entities 212 associated with website 208, privacy settings 214 of website 208, and/or browser notifications 216.

Third party entities 212 may include third party trackers, extensions, sub downloads, websites, and so forth, that can track user navigation to website 208 and/or access information exchanged with website 208. For example, an advertiser or an analytics provider may employ third party entities 212 on multiple different websites in order to track user navigation to the multiple different websites, such as through the user of third-party tracking cookies. Such third party entities may also be able to access a user's information exchanged with websites 208 navigated to using web platform 112, such as passwords, credit card numbers, phone numbers, addresses, and so forth.

Privacy monitoring module 116 can detect third party entities 212 in a variety of different ways. In one or more implementations, privacy monitoring module 116 accesses a list that identifies third party entities, such as a tracking protection list (TPL), a crowd source list, and so forth. Alternately, privacy monitoring module 116 may be specifically configured to detect any and all third party entities 212 associated with a website without accessing a separate list. In one or more implementations, privacy monitoring module 116 can access browsing history data 114 to determine first party websites and third party entities. Privacy monitoring module 116 may use internal heuristics to determine whether a website is a first party website or a third party entity. For example, a first party website includes a domain corresponding to the domain navigated to directly by a user using web platform 112, whereas a third party entity may include a different domain than the domain navigated to using web platform 112.

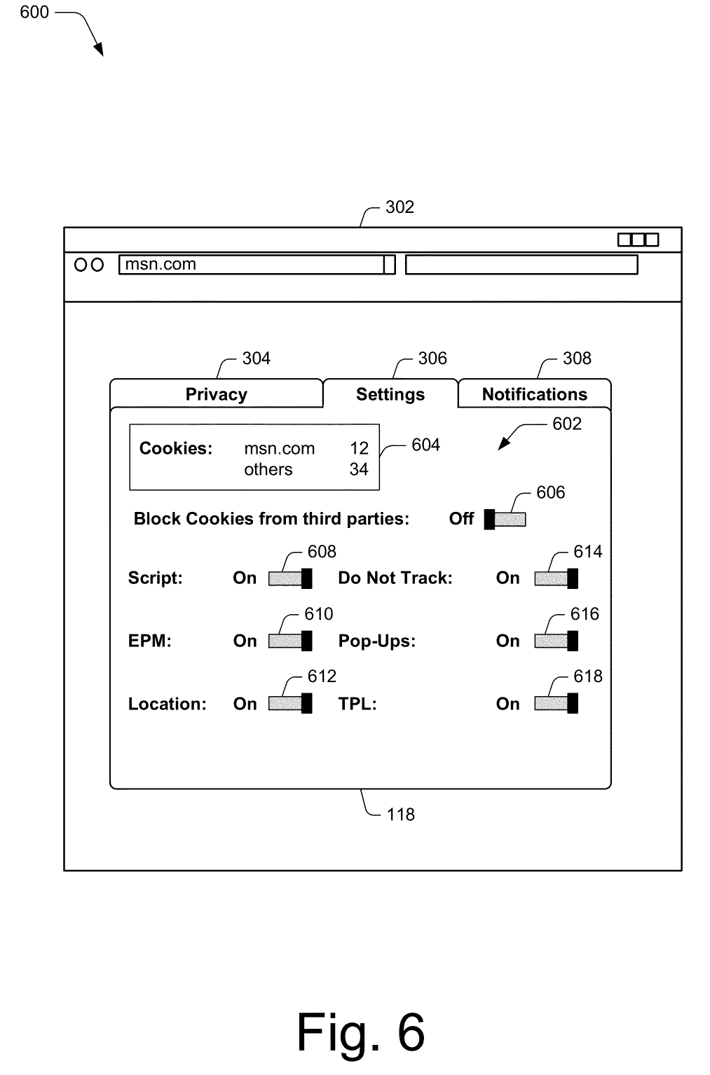

Privacy settings 214 corresponds to settings and/or permissions associated with website 208, such as whether or not to allow the web site to download cookies, whether or not to allow the website to access a geographic location of the user, and so forth. Further discussion of privacy settings 214 can be found with regards to FIG. 6, below.

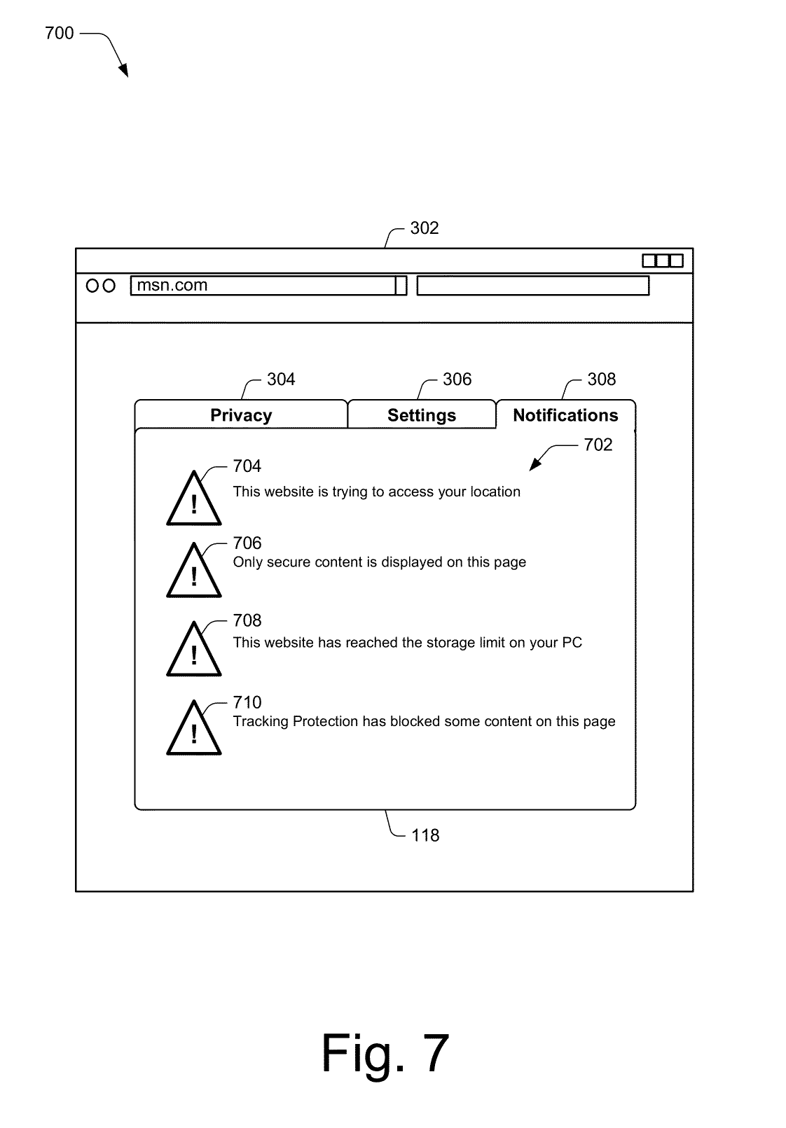

Browser notifications 216 corresponds to notifications associated with website 208. Conventional web browsers may display these notifications in a separate user interface element or pop-up window. Further discussion of browser notifications 216 can be found with regards to FIG. 7, below.

At third stage 206, privacy monitoring module 116 causes display of privacy user interface 118 in web platform 112. Privacy user interface 118 provides a centralized location to display web site information 210, such as third party entities 212, privacy settings 214, and/or browser notifications 216. Additionally, privacy user interface 118 may include one or more privacy controls 218 configured enable the user to manage website information 210.

For example, privacy controls 218 may enable the user to take specific actions with regards to third party entities 212, such as by blocking or preventing the third party entities from tracking navigation to website 208 and/or accessing information exchanged with website 208. Alternately or additionally, privacy controls 218 may enable the user to manage privacy settings 214 of website 208, such as by toggling on or off various permissions related to location, tracking, pop-ups, and so forth.

In one or more implementations, privacy monitoring module 116 causes display of privacy user interface 118 responsive to detecting navigation to website 208 or responsive to detecting third party entities 212. Alternately, privacy monitoring module 116 may cause display of a selectable control in web platform 112 that, responsive to user selection, causes display of privacy user interface 118. The selectable control can be positioned in web platform 112 such that it is easily noticeable by users, and correlated to the current website 208, such as near the address bar of web platform 112. In some cases, the selectable control may be controlled to visually indicate that third party entities 212 are detected, such as by flashing or changing color, which may prompt the user to select the control.

Consider, now, various non-limiting examples of privacy user interface 118 described with regards to FIGS. 3-7, below.

FIG. 3 illustrates an example 300 of a privacy user interface displaying indications of detected third party entities associated with a website in accordance with one or more implementations.

In example 300, privacy user interface 118 is presented in a window 302 of web platform 112, and includes a privacy tab 304, a settings tab 306, and a notifications tab 308. Note, however, that privacy user interface may be presented in any type of user interface element associated with web platform 112. For example, in some implementations privacy user interface may be implemented in a “flyout” user interface from the address bar of the web browser. In example 300, a user has selected privacy tab 304, which causes privacy user interface 118 to display a privacy portion 310 of privacy user interface 118.

Privacy portion 310 enables the user to view information pertaining to third party entities 212 associated with a current website 208 navigated to using web platform 112, which in this example is “msn.com”. As described throughout, third party entities 212, when associated with website 208, can track user navigation to website 208 and/or access information exchanged with website 208.

Conventional web browsers, however, do not enable the user to easily determine the third party entities which are associated with a current website 208 navigated to using web platform 112. In the past, therefore, users often believe that only the first party website navigated to using web platform 112, which in this example is msn.com, would be able to access information from the user.

Now, privacy portion 310 of privacy user interface 118 notifies the user of third party entities 212 that are associated with website 208. To do so, privacy portion 310 includes a third party entity list 312 of each third party entity 212 associated with website 208 that is detected by privacy monitoring module 116, such as third party sub downloads detected on website 208 and/or third party sub downloads blocked on website 208 if adblocking or TPL is turned on. In this example, third party entity list 312 indicates that third party entities “facebook.net”, “msads.net”, “s-msn.com”, “live.com”, and “twitter.com” are associated with msn.com.

Privacy portion 310 of privacy user interface 118 further includes a block control 314. Selection of block control 314 causes web platform 112 prevent the detected third party entities in third party entity list 312 from tracking user navigation to website 208 and/or accessing information exchanged with website 208. Selection of the block control prevents the third party entity from being downloaded on future visits to the first party site and on any other first party site that the user visits in the future. In this example, responsive to receiving a selection of block control 314, web platform prevents facebook.net, msads.net, s-msn.com, live.com, and twitter.com from tracking user navigation to website 208 and/or accessing information exchanged with website 208. Web platform 112 may block third party entities 212 in a variety of different ways. In some cases, web platform 112 blocks the third party entities by blocking access to information, preventing tracking of user navigation, or preventing sub downloads (e.g., files or cookies).

In one or more implementations, privacy portion 310 of privacy user interface 118 may include individual block controls for each third party entity 212 identified in third party entity list 312, which enables the user to block individual third party entities 212. In FIG. 3, for example, privacy portion 310 may include individual block controls to enable the user to block the third party entity “msads.net” without blocking “facbook.net”, “s-msn.com”, “live.com”, and “twitter.com”.

In one or more implementations, selection of block control 314 causes web platform 112 prevent third party entities 212 identified in third party entity list 312 from tracking user navigation to, or accessing information exchanged with, one or more additional websites navigated to using web platform 112. For example, third party entities 212 may be associated with multiple different websites, and thus may be able to track user navigation to multiple websites thereby generating a detailed user profile. Thus, the user may prefer to block not only the third party entity at the current website 208, but also at all future first party websites navigated to using web platform 112.

In one or more implementations, privacy portion 310 of privacy user interface 118 can display, for each third party entity, an indication of one or more additional websites navigated to using web platform 112 at which the third party entity tracked navigation to the additional website or accessed information exchanged with the additional website. To view this information, the user can select individual third party entities 212 from third party entity list 312. For example, selection “facebook.net” from third party entity list 312 causes privacy portion 310 of privacy user interface 118 to provide a list of first party websites at which facebook.net has tracked user navigation and/or accessed information from the user.

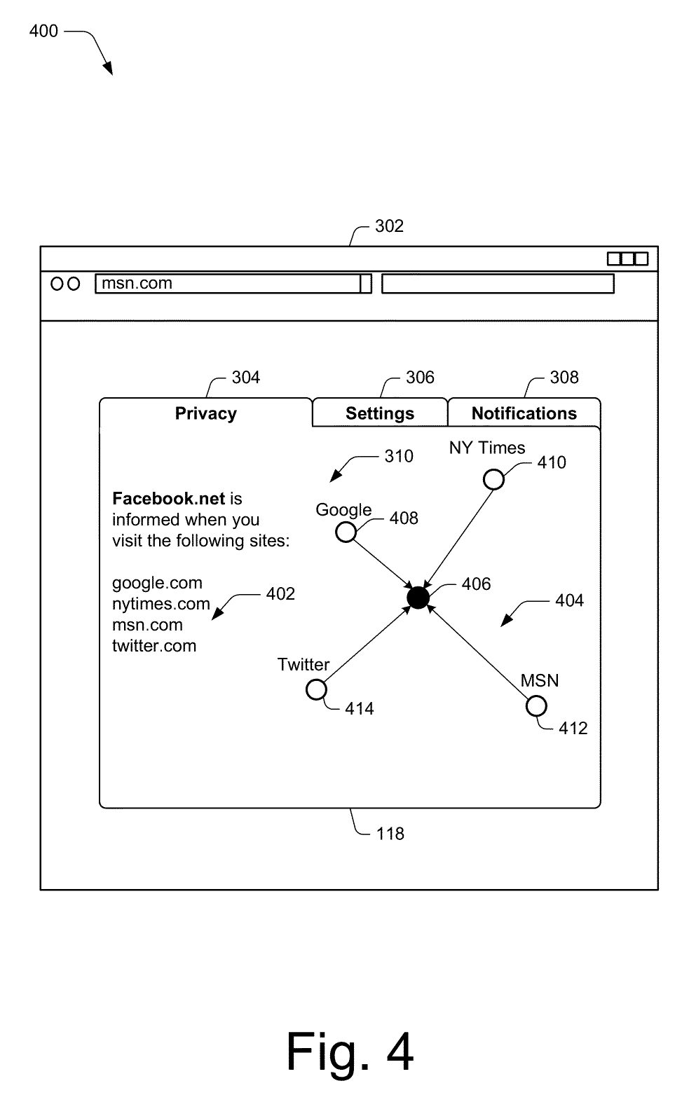

FIG. 4 illustrates an example 400 of a privacy user interface displaying a list of first party websites associated with a third party entity in accordance with one or more implementations.

In this example, privacy portion 310 switches to display a list 402 of first party websites associated with a third party entity in response to selection of the third party entity from third party entity list 312. For example, responsive to the user selecting “facebook.net” from third party entity list 312 in FIG. 3, a list of first party entities associated with facebook.net is displayed in privacy portion 310 of privacy user interface 118. In this example, list 402 includes “google.com”, “nytimes.com”, “msn.com”, and “twitter.com”. By viewing this list, the user can determine that the third party entity facebook.net has tracked user navigation or accessed information from the user at each of these first party websites.

Alternately or additionally, privacy portion 310 of privacy user interface 118 can display a graph 404 that provides a visualization of the relationship between the selected third party entity and the first party websites. In this example, graph 404 includes a node 406 to identify third party entity facebook.net, and nodes 408, 410, 412, and 414 to identify first party websites google.com, nytimes.com, msn.com, and twitter.com, respectively.

It is to be appreciated that list 402 and graph 404 enables the user to see that the third party entity has accessed information from the user across multiple different websites, which may cause the user to realize the third party entity may have enough information to compile a detailed profile about the user without the user's explicit permission.

Thus, based on the information provided in list 402 and/or graph 404, the user may decide to block the third party entity, such as by navigating back to privacy portion 310 illustrated in FIG. 3 and blocking facebook.net to prevent web platform 112 from sharing information with facebook.net during future visits to google.com, nytimes.com, msn.com, twitter, and any other website at which facebook.net is located.

Returning to FIG. 3, privacy portion 310 further includes a graph view control 316 that, responsive to selection, causes privacy portion 310 to display a graph of the relationship of each first party website and third party entity across the user's browsing history.

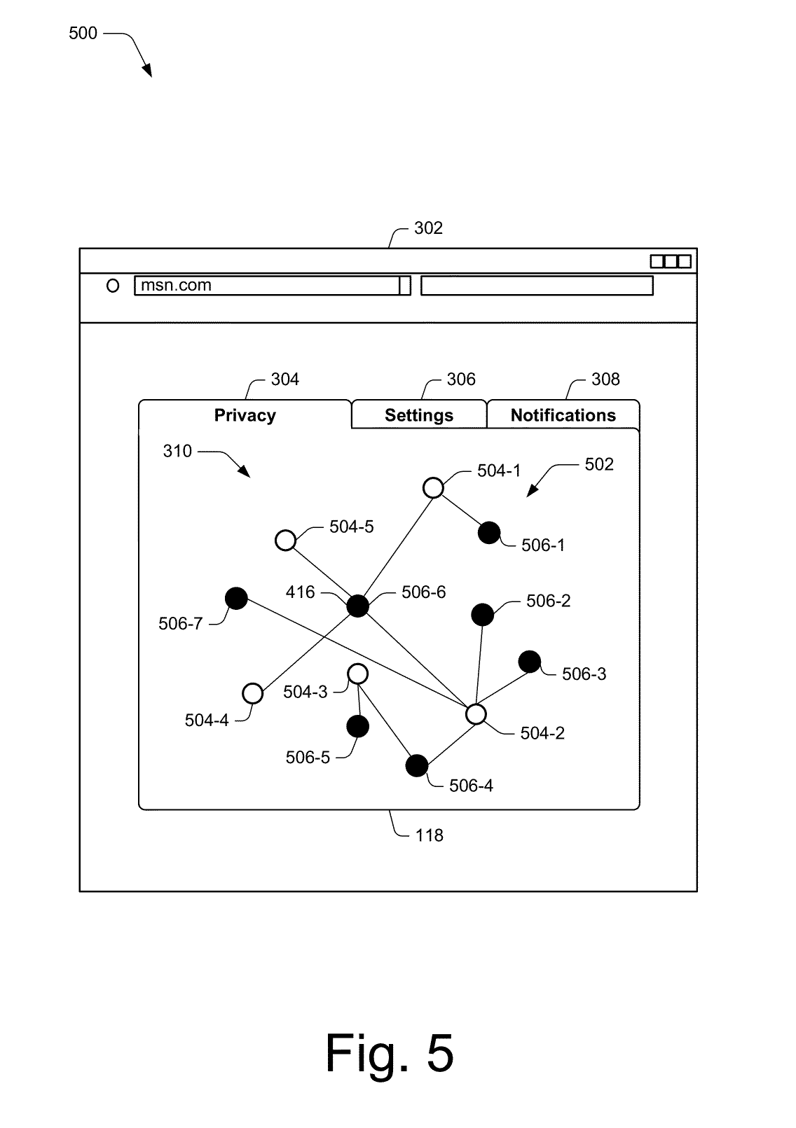

FIG. 5 illustrates an example 500 of a privacy user interface displaying a graph view of the relationship between first party websites and third party entities across a user's browsing history in accordance with one or more implementations.

In this example, privacy monitoring module can track user navigation to multiple first party websites using web platform 112, such as by accessing the user's browsing history. Additionally, for each first party website navigated to using web platform 112, privacy monitoring module 116 can detect and record the third party entities associated with the first party website. As noted throughout, in some cases third party entities may be associated with multiple first party websites navigated to by the user using web platform 112.

Privacy monitoring module 116 is configured to map relationships between the multiple websites 208 navigated to using web platform 112 and third party entities 212 associated with one or more of the multiple websites. In some cases, privacy monitoring module 116 can display, in privacy user interface 118, a graph depicting the relationships between multiple websites 208 navigated to using web platform 112 and third party entities 212 associated with one or more of the multiple websites.

In this example, privacy portion 310 of privacy user interface 118 provides a graph 502 that depicts the relationships between websites 208 navigated to using web platform 112 and third party entities 212. Graph 502 includes nodes 504 representative of websites 208, and additional nodes 506 representative of the third party entities. For example, nodes 504 representative of websites 208 include nodes 504-1, 504-2, 504-3, 504-4, and 504-5, and nodes 506 representative of third party entities 212 include nodes 506-1, 506-2, 506-3, 506-4, 506-5, 506-6, and 506-7.

In one or more implementation, nodes 504 representative of the websites are visually different than nodes 506 representative of the third party entities to enable the user to visually distinguish first party websites from third party entities. For instance, nodes 504 are colored white, whereas nodes 506 are colored black. In some cases, the nodes 504 and 506 may include an identifier (e.g., a logo or name of the website or third party entity) to enable identification of each website and third party entity.

Notably, graph 502 enables the user to quickly and easily see the relationship between the first party websites and the third party entities. In this example, graph 502 includes links (e.g., lines) between nodes 504 representative of the websites and nodes 506 representative of the third party entities. The links enable the user to view, for each first party website, each of the third party entities that are associated with the first party website. In addition, the links enable the user to view, for each third party entity, each of the first party websites at which the third party entity is located. For example, for each first party website, the user can follow the lines to identify third party entities associated with the first party website. Similarly, for each third party entity, the user can follow the lines to identify first party websites at which the third party entity is located. For example, graph 502 shows that the first party website identified by node 504-2 includes third party entities identified by nodes 506-2, 506-3, 506-4, 506-6, and 506-7. As another example, graph 502 shows that the third party entity identified by node 506-6 is located at the first party websites identified by nodes 504-1, 504-2, 504-4, and 504-5.

FIG. 6 illustrates an example 600 of a privacy user interface displaying privacy and/or security settings associated with a website in accordance with one or more implementations.

In example 600, a user has selected settings tab 306 to display a settings portion 602 of privacy user interface 118. Settings portion 602 is configured to display indications of privacy settings 214 associated with website 208 that are detected by privacy monitoring module 116.

Many conventional web browsers do not enable the user to view the settings or permissions which are granted to a current website. Thus, the user may not realize that when the user navigates to a certain website, the website may have permission to access the user's geographic location, provide pop-up windows, track the user's visit, and so forth.

Now, settings portion 602 enables the user to view settings or permissions associated with website 208 navigated to using web platform 112. Additionally, settings portion 602 enables the user to modify the settings and permission associated with website 208, such as by allowing or disallowing the various permissions. To do so, settings portion 602 includes one or more controls selectable to modify the privacy settings associated with website 208.

In this example, settings portion 602 includes cookie information 604 which indicates the number of cookies downloaded for the current website 208 navigated to using web platform 112, as well as the number of cookies downloaded by third party entities associated with the current website 208. In this example, cookie information 604 indicates that 12 cookies have been downloaded by msn.com, and 34 cookies have been downloaded by third party entities associated with msn.com.

Settings portion 602 further includes a cookie control 606 which enables the user to block cookies by preventing web platform 112 from downloading cookies from the current website and from third party entities associated with the current website. In this example, cookie control 606 is implemented in the form of a toggle control that can toggle on and off the ability to block cookies. Currently, cookie control is set to enable cookies to be downloaded, and thus 12 cookies have been downloaded by msn.com, and 34 cookies have been downloaded by third party entities. If, however, the user switches cookie control 606 to “on”, web platform will prevent any additional cookies from being downloaded by the current website 208 or the third party entities associated with the current website.

Settings portion 602 includes multiple additional controls for various other settings associated with the current website 208. The additional controls can also be toggled “on” or “off” to allow or restrict the various settings and permissions associated with website 208.

In this example, the controls include a script control 608, an enhanced protected mode (EPM) control 610, a location control 612, a tracking control 614, a pop-ups control 616, and a TPL control 618. It is to be appreciated that additional controls corresponding to additional settings or permissions of website 208 may also be displayed in settings portion 602.

The user can select each of controls 608-618 to toggle the respective setting “on” or “off”. For example, the user can select location control 612 to allow or prevent website 208 from accessing the user's current geographic location. Similarly, the user can select tracking control 614 to allow or prevent website 208 from tracking the user's visits to website 208.

FIG. 7 illustrates an example 700 of a privacy user interface displaying notifications associated with a website in accordance with one or more implementations.

In example 700, a user has selected notifications tab 308 to display a notification portion 702 of privacy user interface 118. Notification portion 702 is configured to display one or more indications of browser notifications 216 associated with website 208 that are detected by web platform 112. Notably, conventional web browsers present such notifications as separate user interface elements or pop-up windows. However, these separate user interface elements often interfere with the user's browsing experience by blocking the current browsing page, which can be frustrating and annoying to users.

Privacy monitoring module 116 is configured to intercept browser notifications 216 from web platform 112, and present the browser notifications 216 in notification portion 702 of privacy user interface 118. Presenting the browser notifications 216 in notification portion 702, instead of in a pop-up window, enables the user to choose whether or not to view the notifications and does not interfere with the user's browsing experience. In one or more implementations, privacy monitoring module 116 only provides “non-critical” browser notifications 216 in notification portion 702 of privacy user interface 118.

In this example, notification portion 702 includes notifications 704, 706, 708, and 710, which correspond to the following notifications, “the website is trying to access your location”, “only secure content is displayed on this page”, “this website has reached the storage limit on your PC”, and “tracking protection has blocked some content on this page”. It is to be appreciated, however, that notification portion 702 may be configured to display any type of notification associated with a current website 208, which are typically provided in a separate pop-up window or other notification user interface (e.g., a yellow bar displayed at the bottom of a web browser window).

In some cases users may be uncomfortable having privacy monitoring module track information regarding navigation to various websites using web platform 112. Thus, the functionality of privacy monitoring module 116 can be toggled on or off by the user.

Further, in one or more implementations, all of the data detected by privacy monitoring module 116 can be stored locally so that the user does not need to worry about the detected data being transmitted to the cloud. In other cases, however, the data detected by privacy monitoring module can be collected across multiple devices associated with the user, and stored in the cloud.

Example Methods

The methods described herein are shown as sets of blocks that specify operations performed but are not necessarily limited to the order or combinations shown for performing the operations by the respective blocks. In portions of the following discussion reference may be made to environment 100 of FIG. 1 and system 200 of Fig., reference to which is made for example only. The techniques are not limited to performance by one entity or multiple entities operating on one device.

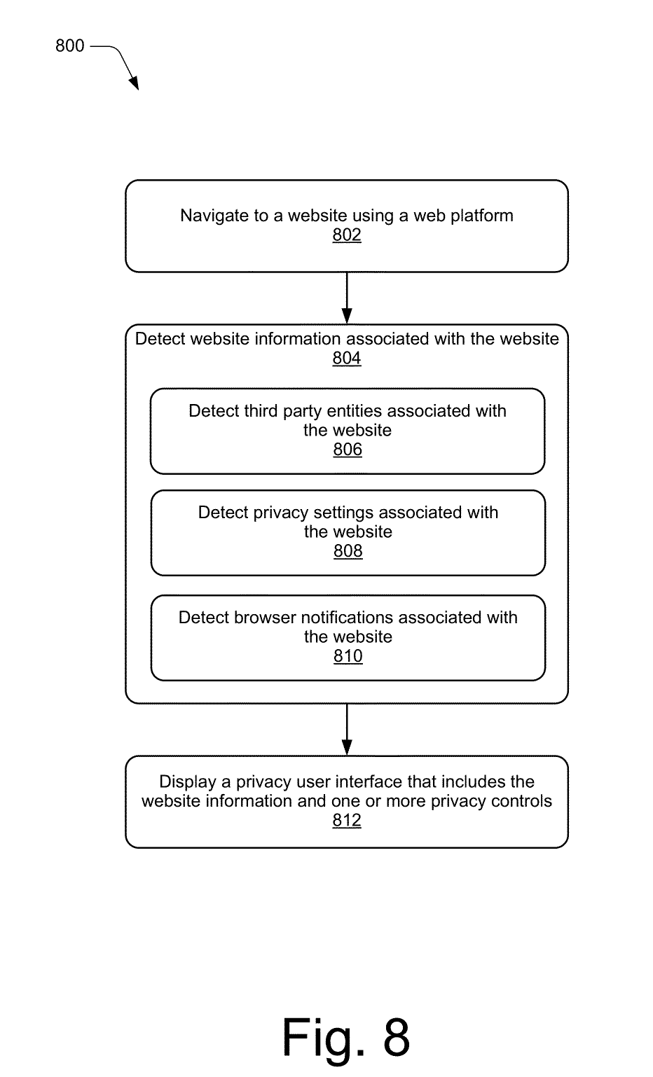

FIG. 8 illustrates an example method 800 of detecting website information associated with a website, and displaying a privacy user interface. At 802, a website is navigated to using a web platform. For example, website 208 (FIG. 2) is navigated to using web platform 112 (FIG. 1).

At 804, website information associated with the website is detected. For example, privacy monitoring module 116 detects website information 210 associated with website 208. Step 804 can include steps 806, 808, and/or 810.

At 806, third party entities associated with the website are detected. For example, privacy monitoring module 116 detects third party entities 212 that are associated with website 208. Third party entities 212 can track user navigation to website 208 and/or access information exchanged with website 208.

At 808, privacy settings associated with the website are detected. For example, privacy monitoring module 116 detects privacy settings 214 associated with website 208.

At 810, browser notifications associated with the website are detected. For example, privacy monitoring module 116 detects browser notifications 216 associated with website 208.

At 812, a privacy user interface that includes the website information and one or more privacy controls is displayed. For example, privacy monitoring module 116 causes display of privacy user interface 118 in web platform 112. Privacy user interface 118 may include website information 210, such as third party entities 212, privacy settings 214, and browser notifications 216. In addition, privacy user interface 118 can include one or more privacy controls 218. For example, privacy controls 218 may include block control 314, graph view control 316, cookie control 606, script control 608, EPM control 610, location control 612, tracking control 614, pop-ups control 616, TPL control 618, and so on.

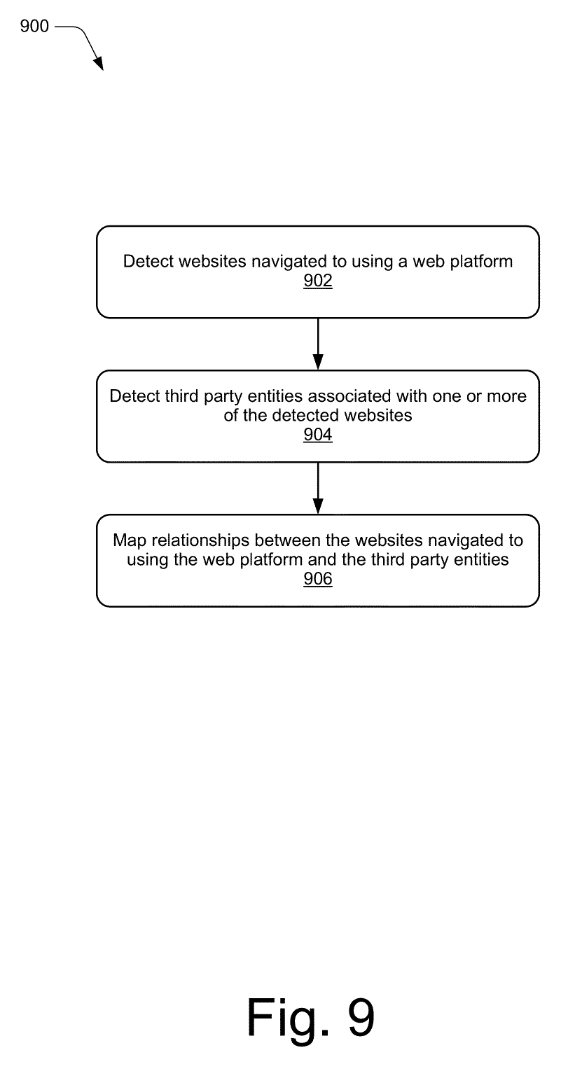

FIG. 9 illustrates an example method 900 of mapping relationships between websites navigated to using a web platform and third party entities.

At 902, websites navigated to using a web platform are detected. For example, privacy monitoring module 116 detects websites 208 navigated to using web platform 112.

At 904, third party entities associated with one or more of the websites navigated to using the web platform are detected. For example, privacy monitoring module 116 detects third party entities 212 associated with one or more of the websites 208 navigated to using web platform 112.

At 906, relationships between the websites navigated to using the web platform and the third party entities are mapped. For example, privacy monitoring module 116 maps relationships between websites 208 navigated to using web platform 112 and third party entities 212. In one or more implementations, privacy monitoring module 116 may be further configured to generate a graph 502 that depicts the relationships between websites 208 navigated to using web platform 112 and third party entities 212.

### Example Device

FIG. 10 illustrates an example system 1000 that includes an example device 1002, which can implement embodiments of a privacy user interface for websites. The example device 1002 can be implemented as any of the computing devices described with reference to the previous FIGS. 1-9, such as any type of client device, mobile phone, tablet, computing, communication, entertainment, gaming, media playback, and/or other type of device. For example, computing device 102 shown in FIG. 1 may be implemented as the example device 1002.

The device 1002 includes communication devices 1004 that enable wired and/or wireless communication of device data 1006, such as location signature data, positioning system data, and/or wireless radio systems data. Additionally, the device data can include any type of audio, video, and/or image data. The communication devices 1004 can also include transceivers for cellular phone communication and for network data communication.

The device 1002 also includes input/output (I/O) interfaces 1008, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 1002 includes a processing system 1010 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1002 may further include any type of a system bus or other data and command transfer system that couples the various components within the device. A system bus can include any one or combination of different bus structures and architectures, as well as control and data lines.

The device 1002 also includes a computer-readable storage memory 1012, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations.

The computer-readable storage memory 1012 provides storage of the device data 1006 and various device applications 1014, such as an operating system that is maintained as a software application with the computer-readable storage memory and executed by the processing system 1010. In this example, the device applications include privacy monitoring module 116 that implements embodiments of privacy user interface for websites, such as when the example device 1002 is implemented as computing device 102 shown in FIG. 1.

The device 1002 also includes an audio and/or video system 1018 that generates audio data for an audio device 1020 and/or generates display data for a display device 1022. The audio device and/or the display device include any devices that process, display, and/or otherwise render audio, video, display, and/or image data. In implementations, the audio device and/or the display device are integrated components of the example device 1002. Alternatively, the audio device and/or the display device are external, peripheral components to the example device.

In embodiments, at least part of the techniques described for privacy user interface for websites may be implemented in a distributed system, such as over a “cloud” 1024 in a platform 1026. The cloud 1024 includes and/or is representative of the platform 1026 for services 1028 and/or resources 1030. For example, the services 1028 and/or the resources 1030 may include the activity module and/or the suggestion module.

The platform 1026 abstracts underlying functionality of hardware, such as server devices (e.g., included in the services 1028) and/or software resources (e.g., included as the resources 1030), and connects the example device 1002 with other devices, servers, etc. The resources 1030 may also include applications and/or data that can be utilized while computer processing is executed on servers that are remote from the example device 1002. Additionally, the services 1028 and/or the resources 1030 may facilitate subscriber network services, such as over the Internet, a cellular network, or Wi-Fi network. The platform 1026 may also serve to abstract and scale resources to service a demand for the resources 1030 that are implemented via the platform, such as in an interconnected device embodiment with functionality distributed throughout the system 800. For example, the functionality may be implemented in part at the example device 1002 as well as via the platform 1026 that abstracts the functionality of the cloud 1024.

### Conclusion and Example Implementations

Example implementations described herein include, but are not limited to, one or any combinations of one or more of the following examples:

A computer-implemented method comprising navigating, using a web platform, to a website; detecting one or more third party entities associated with the website; and displaying a privacy user interface that includes a third party entity list of the one or more third party entities associated with the website, and a block control selectable to prevent the one or more third party entities from tracking navigation to the website or accessing information exchanged with the website.

A computer-implemented method as described above, further comprising responsive to receiving a selection of the block control associated with one of the third party entities, preventing the third party entity from at least one of tracking navigation to the website or accessing information exchanged with the website.

A computer-implemented method as described above, wherein the selection of the block control further causes the web platform to prevent the third party entity from at least one of tracking navigation to one or more additional websites or accessing information exchanged with the one or more additional websites.

A computer-implemented method as described above, further comprising, for each third party entity, displaying, in the privacy user interface, an indication of one or more additional websites navigated to using the web platform at which the third party entity tracked navigation to the additional website or accessed information exchanged with the additional website.

A computer-implemented method as described above, further comprising, displaying, in the privacy user interface, a graph depicting relationships between multiple websites navigated to using the web platform and third party entities associated with one or more of the multiple websites.

A computer-implemented method as described above, further comprising detecting one or more privacy settings associated with the website; and displaying, in the privacy user interface, indications of the one or more privacy settings associated with the website.

A computer-implemented method as described above, further comprising displaying, in the privacy user interface, one or more controls selectable to modify the privacy settings.

A computer-implemented method as described above, wherein the one or more controls selectable to modify the privacy settings comprise one or more of a block cookie control, a script control, an enhanced protected mode (EPM) control, a location control, a tracking control, a pop-ups control, or a tracking protection list (TPL) control.

A computer-implemented method as described above, further comprising detecting one or more browser notifications associated with the website; and displaying, in the privacy user interface, one or more indications of the detected browser notifications.

A computing device, comprising a display; and at least a memory and a processor to implement a web platform, the web platform configured to navigate to a website; and cause display of a privacy user interface on the display, the privacy user interface including at least a privacy portion and a settings portion; the privacy portion of the privacy user interface including a third party entity list of one or more third party entities associated with the website navigated to using the web platform, and a block control selectable to prevent the one or more third party entities from tracking navigation to the website or accessing information exchanged with the website; and the settings portion of the privacy user interface including indications of privacy settings associated with the website, and one or more controls selectable to modify the privacy settings.

A computing device as described above, wherein responsive to receiving a selection of one of the third party entities from the third party entity list, the privacy portion is configured to display an indication of one or more additional websites navigated to using the web platform at which the third party entity is located.

A computing device as described above, wherein the privacy portion is further configured to display a graph depicting relationships between multiple websites navigated to using the web platform and third party entities associated with one or more of the multiple websites.

A computing device as described above, wherein the privacy user interface further includes a notification portion, the notification portion including indications of one or more notifications associated with the website.

A computing device as described above, wherein the privacy portion, the settings portion, and the notification portion are each displayed in a different tabbed page of the privacy user interface.

A system comprising a privacy monitoring module, implemented at least partially in hardware, and configured to perform operations comprising detecting websites navigated to using a web platform; detecting third party entities associated with one or more of the websites navigated to using the web platform; and mapping relationships between the websites navigated to using the web platform and the third party entities.

A system as described above, wherein the privacy monitoring module is further configured to perform operations comprising displaying a graph that depicts the relationships between the websites navigated to using the web platform and the third party entities.

A system as described above, wherein the graph includes nodes representative of the websites and additional nodes representative of the third party entities, and wherein the nodes representative of the websites are visually different than the nodes representative of the third party entities.

A system as described above, wherein the graph includes links between the nodes representative of the websites and the additional nodes representative of the third party entities, wherein the links show the relationships between the websites and the third party entities.

A system as described above, wherein the privacy monitoring module is configured to detect the websites by accessing browsing history data.

A system as described above, wherein the privacy monitoring module is configured to detect the third party entities by accessing a tracking protection list (TPL) or a crowd source list.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

1. A computer-implemented method comprising:
navigating, using a web platform, to a website;
detecting, by a privacy monitoring module that is distinct from the web platform and the website, one or more third party entities associated with the website;
displaying a privacy user interface that includes a third party entity list of the one or more third party entities associated with the website, and a block control selectable to prevent the one or more third party entities from tracking navigation to the website or accessing information exchanged with the website;
receiving a selection of one of the one or more third party entities from the third party entity list; and
responsive to receiving the selection of one of the one or more third party entities from the third party entity list, displaying, in the privacy user interface, an indication of one or more additional websites at which the selected third party entity tracked navigation or accessed information.

2. The computer-implemented method as recited in claim 1, further comprising responsive to receiving a selection of the block control associated with one of the third party entities, preventing the third party entity from at least one of tracking navigation to the website or accessing information exchanged with the website.

3. The computer-implemented method as recited in claim 2, wherein the selection of the block control further causes the web platform to prevent the third party entity from at least one of tracking navigation to one or more additional websites or accessing information exchanged with the one or more additional websites.

4. (canceled)

5. The computer-implemented method as recited in claim 1, wherein the displaying the indication further comprises displaying, in the privacy user interface, a graph depicting information flow relationships between the selected third party entity, the website, and the one or more additional websites.

6. The computer-implemented method as recited in claim 1, further comprising:
detecting, by the privacy monitoring module, one or more privacy settings associated with the website; and
displaying, in the privacy user interface, indications of the one or more privacy settings associated with the website.

7. The computer-implemented method as recited in claim 6, further comprising displaying, in the privacy user interface, one or more controls selectable to modify the privacy settings.

8. The computer-implemented method as recited in claim 7, wherein the one or more controls selectable to modify the privacy settings comprise one or more of a block cookie control, a script control, an enhanced protected mode (EPM) control, a location control, a tracking control, a pop-ups control, or a tracking protection list (TPL) control.

9. The computer-implemented method as recited in claim 1, further comprising:
detecting, by the privacy monitoring module, one or more browser notifications associated with the website; and
displaying, in the privacy user interface, one or more indications of the detected browser notifications.

10. A computing device, comprising:
a display; and
at least a memory and a processor to implement a web platform, the web platform configured to:
navigate to a website; and
responsive to detecting, by a privacy monitoring module distinct from the web platform and the website, one or more third party entities or one or more privacy settings associated with the web site, cause display of a privacy user interface on the display, the privacy user interface including at least a privacy portion and a settings portion;
the privacy portion of the privacy user interface including a third party entity list of one or more third party entities associated with the web site navigated to using the web platform, and a block control selectable to prevent the one or more third party entities from tracking navigation to the website or accessing information exchanged with the website, wherein responsive to receiving a selection of one of the one or more third party entities from the third party entity list, the privacy portion is configured to display an indication of one or more additional websites at which the selected third party entity tracked navigation or accessed information, the displaying the indication comprising displaying a graph depicting information flow relationships between the selected third party entity, the website, and the one or more additional websites; and
the settings portion of the privacy user interface including indications of privacy settings associated with the website, and one or more controls selectable to modify the privacy settings, the one or more controls selectable to modify the privacy settings comprise one or more of a block cookie control, a script control, an enhanced protected mode (EPM) control, a location control, a tracking control, a pop-ups control, or a tracking protection list (TPL) control.

11. (canceled)

12. (canceled)

13. The computing device as recited in claim 10, wherein the privacy user interface further includes a notification portion, the notification portion including indications of one or more notifications associated with the web site.

14. The computing device as recited in claim 13, wherein the privacy portion, the settings portion, and the notification portion are each displayed in a different tabbed page of the privacy user interface.

15. A system comprising:
a privacy monitoring module, implemented at least partially in hardware, and configured to perform operations comprising:
detecting websites navigated to using a web platform;
detecting third party entities associated with one or more of the websites navigated to using the web platform;
mapping relationships between the websites navigated to using the web platform and the third party entities;
displaying a graph that depicts the relationships between the websites navigated to using the web platform and the third party entities;
receiving a selection of one of the one or more third party entities from the graph; and
responsive to receiving the selection of one of the one or more third party entities from the graph, displaying an indication of one or more additional websites at which the selected third party entity tracked navigation or accessed information, the displaying the indication comprising displaying an additional graph depicting information flow relationships between the selected third party entity, the website, and the one or more additional websites.

16. (canceled)

17. The system as recited in claim 15, wherein the graph includes nodes representative of the websites and additional nodes representative of the third party entities, and wherein the nodes representative of the websites are visually different than the nodes representative of the third party entities.

18. The system as recited in claim 17, wherein the graph includes links between the nodes representative of the websites and the additional nodes representative of the third party entities, wherein the links show the relationships between the websites and the third party entities.

19. The system as recited in claim 15, wherein the privacy monitoring module is configured to detect the websites by accessing browsing history data.

20. The system as recited in claim 15, wherein the privacy monitoring module is configured to detect the third party entities by accessing a tracking protection list (TPL) or a crowd source list.

21. The system as recited in claim 15, wherein the privacy monitoring module is configured to perform operations further comprising:
presenting a block control selectable to prevent one or more of the third party entities from tracking navigation to the website or accessing information exchanged with the website.

22. The system as recited in claim 21, wherein the privacy monitoring module is configured to perform operations further comprising, responsive to receiving a selection of the block control associated with one of the third party entities, preventing the third party entity from at least one of tracking navigation to the website or accessing information exchanged with the website.

23. The system as recited in claim 22, wherein the selection of the block control further causes the web platform to prevent the third party entity from at least one of tracking navigation to one or more additional websites or accessing information exchanged with the one or more additional websites.

24. The system as recited in claim 15, wherein the privacy monitoring module is configured to perform operations further comprising:
detecting one or more privacy settings associated with the website; and
displaying indications of the one or more privacy settings associated with the website.
